(19) United States
(12) Patent Application Publication
(10) Pub. No.: US 2010/0171888 A1
(43) Pub. Date: Jul. 8, 2010

(54) Video frame recorder

(76) Inventors: Hipolito Saenz, Pasadena, TX (US); Virginia Saenz, Pasadena, TX (US)

Correspondence Address: LAW OFFICE OF DAVID MCEWING, P.O. BOX 231324, HOUSTON, TX, 77023, US

(21) Appl. No.: 12/231,427

(22) Filed: Jan. 5, 2009

(51) Int. Cl. H04N 5/66

(52) U.S. Cl. 348/739; 348/E05.133

(57) ABSTRACT

The invention comprises a video framed electronic frame display screen with a touch screen LCD, a power supply (either DC battery powered or AC power cord), a memory component, video and audio input and output jacks adaptable to DVD and VCR players, cameras and mp3 players, and speakers. The video frame display screen can be controlled by operation of the touch screen display or by a remotely operated infra-red controller.

### BACKGROUND OF INVENTION

1. Field of Use

The invention may be used for purposes including a decorative frame surrounding an electronic display screen for still photos or video clips. Visual display can be accompanied by an audio component. The invention can also perform editing of photos and videos. Audio can be added and synchronized with specific photos or videos.

2. Related Technology

Electronic picture viewing apparatus for displaying electronic images in a picture frame type setting are known.

### SUMMARY OF INVENTION

The invention comprises an video frame electronic display screen with speakers, a touch screen LCD, a power supply (either DC battery or through an AC power cord), a memory component and preferably 10 gigabytes of memory, video and audio input and output jacks adaptable to DVD and VCR players, cameras and mp3 players. The video frame display screen can be controlled via the touch display screen or by a remotely operated infra-red controller.

### SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 is a front view of the video frame component surrounding the video screen with the microphone port and the infra-red signal receiving port.

FIG. 2 is a side view of the video frame.

FIG. 3 is a perspective view of the video frame.

FIG. 4 is a perspective view of the interior of the video frame back panel showing the wall mounting component and ports for peripheral components located on the side.

FIG. 5 is a cross sectional view of the device showing the remote control device stored on the back and also a wall mounting component located on the back.

FIG. 6 is a cross sectional view of the port for the infra-red signal detector and corresponding to the arrows marked 6 in FIG. 1.

FIG. 7 is a cross sectional view of the video frame corresponding to the arrows marked 7 in FIG. 1.

FIG. 8 is exterior perspective drawing of the back cover of the video frame.

FIG. 9 is view of the back cover of the video frame.

FIG. 10 is a side view of the video frame.

FIG. 11 is a perspective view of the back of the video frame illustrating a stand component that can hold the video frame upright on a flat surface.

FIG. 12 is a perspective view of a remote control that may be used with the video frame.

FIG. 13 is an exploded view of the video frame including the front frame cover, the LCD screen, the PCB memory component, back cover and stand.

### DETAILED DESCRIPTION OF INVENTION

The following is a listing of some of the components of the Video Frame Recorder (hereinafter “video frame”). The video frame has at least one speaker; a port for a microphone which is a way to record audio into the video frame; the way the video frame may stand vertical or horizontal; an infra-red remote controller; a TFT LCD touch screen display; slot for sd/mmc card; USB port; compact flash II microdrive port; flash card ejector; USB port 2.0; slot for blue light on the video frame bottom when sitting horizontal or vertical; slot for wall-hanging of the video frame; space slots on the back where the remote control can be stored; audio in-audio out; video in-video out; dimples for placement of the video frame in a vertical or horizontal position; 12V DC in port also place for battery pack (Lithium ion) and an AC power cord.

To begin with, the video frame will use an array of blue/green/amber light on bottom of the video frame and the light-changes color as the battery is going dead. The video frame also contains a switch to turn off/on the components of the video frame. The video frame may also have a to accept a plug from cell phones and cameras, and separate memory devices, including but not limited to pcs and laptops, to transfer pictures and videos.

The video and audio inputs and output jacks of the video frame are to receive recorded signals from DVD's, VCR's, and mp3s. Any chip that is inserted into the video frame can also transfer to the memory component of the video frame (that can hold ten gigs) and can also send video clips back to the chip or still pictures. You can send to and from the video frame. The video frame will also have albums to where you can store section of friends videos or pictures and other albums that you can store family pictures or videos. With the video frame you can also erase blurred parts of the video. The video frame will also play an entire video clip to pause a frame and download to a video frame. If you are playing a video that has a recording of 1 minute then you pause the video whenever you see the selected scene, then download to the video frame memory. You can then send back any of the clips that are being used and then you can have the picture printed out on a machine that prints pictures. The video frame will also have a “zoom in” “zoom out” button so you can zoom in or zoom out 16 times magnification from a still picture or video played. The whole video frame receives any video chip or picture chip with sound or movement. Any picture or video on the video frame can be rotated up to 360° degrees so when you rotate a picture on the camera you can view it just like you want. The video frame will also have ways to display a picture with or without sound. The video frame will also have a settings that shows or controls the properties of the video frame memory status, memory left, change the brightness, tone, contrast and other qualities of the image as sound as well as modify the date, time, alarm, settings etc.

When the alarm goes off the video frame can display a picture with the sound of the recorded message that the owner has put in or other manner of sound such as the music that was able to be transferred to the picture or video on the frame. Alarm goes off and a video comes on and displays a video recorded live, mom was recorded and saying “ok son, wake up, its time to go to school”. The video frame alarm had come on with sound of mommy from the speakers and even though mom was not there, the video frame said it all as of she was there.

The video frame has a slide transition. The user can personalize the way he views an array/group of images. He can choose to have them displayed at random or in an order. Videos or pictures can work in this slide transition. He can choose a particular “frame” from a list of options so that the video frame has a new visual identity each time he uses it.

Volume controls—the user can set the volume of the video that is being played or the music that the picture frame plays in the background of the images. By talking to the video frame you can record a background narration under the sound it already has or record over the sound that the video or picture already has. There may be three ways to record on a still frame or video clip; low, medium or high. The low is the background, the medium is normal level and the high is over the sound already used. The video frame will have buttons to use on touch screen or remote control such as nextprevious buttons and scroll onto albums. These buttons will help the user to go through the slide show by fast forwarding it. When in video mode the button helps fast forward and rewind the video clips. The longer you press the button the faster it moves from normal to 16×. The video frame can also be used as a daily diary, which everyone wants to keep. The video frame will also take a small picture, like from a phone and view it onto a big screen TV. This means you can use this one size video frame and view it into any size TV to see the big picture right away. You would not have to buy other sizes.

The video frame uses all clips that are used in cell phones, cameras, video cameras and other items as well as from the computer. The video frame can store information, pictures, video clips, music-mp3.

The invention comprises a video frame. The video frame is connected to at least one speaker. Preferably the speakers are built into the video frame. The video frame may include slots to distribute the sound from the speakers into the room. Built into the video frame are also a sound player and recorder. The video frame can have a port for receiving a signal from a microphone. The video frame also includes an input port for audio. The video frame also includes audio output. The microphone and audio input may directly interface with the memory component of the video frame.

The video frame also includes a touch controlled LCD screen. The touch component may be one of multiple technologies such a resistive touch screen panel, surface acoustic wave technology, capacitive and projected capacitance. A still image or video display may be positioned within the decorative frame component to provide the illusion of a picture within a traditional frame.

The video frame can be positioned horizontally, i.e., having a broad base relative to the video frame height. Alternatively, the video frame can be positioned vertically, i.e., having a narrow base relative to the video frame height. The video frame can be square and rotated 90° for mounting.

Included is also an infra-red controller to control the functions of video frame components (described below). The infra-red signal receiver receives signals from a remote control device. The signal receiver may be located on the front of the video frame.

A principal component of the video frame is the thin film transistor, a type of a liquid crystal display “LCD” flat-panel display screen in which each pixel may be controlled by one to four transistors. This screen is hereinafter referred to “TFT-LCD touch screen display”. The TFT glass has as many TFTs as the number pixels displayed. Preferably the TFT LCD screen utilizes active-matrix driving or active addressing. In active-matrix LCDs, a switching device and a storage capacitor are integrated at each cross point of the electrodes. The active addressing removes the multiplexing limitation by incorporating an active switching element. Active matrix LCDs have no inherent limitation in the number of scan lines, and they present fewer cross-talk issues. The touch screen feature can be achieved through the various technologies available. These include but are not limited to resistive, surface acoustic wave, capacitive, projected capacitance or strain gauge.

In addition to the TFT-LCD touch screen display and the audio player and recorder, the video frame includes other components including a memory chip. Preferably the chip will have 10 gigabytes (10×1024³ bytes) of memory. The memory may be on a printed circuit board (sometimes designated “PCB”). The video frame may include components to record images from a digital camera and display data from the memory chip or card, for example the SD/MMC card. The data can be displayed on the TFT-LCD touch screen display.

The video frame may also include an infra-red remote receiver in communication with the memory chip or card, video and audio input and output, USB, the TFT-LCD touch screen display, audio player, and video player.

For example, the touch screen can display instructions or icons that allow the user to control the actions of the video frame by touching the appropriate instruction or icon. In one embodiment, an initial touching may “freeze” the frame in a video clip. Alternatively, the screen may display topical lists such as “picture”, “sound”, “date/calendar”, “memory” or “settings”. The touch screen may contain a paused video image. The instructions or listings are display over the paused image. If “settings” is selected, a submenu may appear including “play a sound”, “record a voice over”, “edit background sound” or “mute”. The user can press the instruction for “record a voice over”. The user's speech is saved on the video frame memory in conjunction with video (also stored on memory). In another example, the screen icons can list “set clock”, “set alarm”, “select alarm program”. The alarm program may include a video clip or still photo.

Other components may include a microphone port, infra-red remote receiver, slot for the SD/MMC card or similar card, a compatible card reader, at least one USB port, compact flash II microdrive port (USB 2.0 port); flash card ejector; slot for LED lights proximate to the frame surrounding the TFT-LCD video screen; slot for wall-hanging of the video frame, space slots on the back where the remote can be stored; audio in/audio out; adaptations to the video frame for placement of the video frame in a vertical or horizontal position; and a 12V DC port connection and battery pack holder. Preferably lithium ion batteries will be utilized.

In regard to the LED lights which may be optionally emitted from the bottom of the frame surrounding the TFT-LCD video screen, the frame will use an array of blue/green/amber lights. There may be two sets of LEDs, one for each video frame side that may be the video frame bottom. The light color may change from blue to green and then amber as the battery loses power. It will be appreciated that other colors may be used and are within the scope of this invention.

The video frame may contain video and audio input and output jacks adaptable to DVD and VCR players and to mp3 players. This allows video clips with audio to be played or displayed on the video frame as well as downloaded onto the memory of the video frame. Further, video clips can be transferred from the memory of the video frame, e.g. SD/MMC, to another memory device. The video and audio input and output jacks can be used to connect video and audio cable to the video frame and a television or other monitor to display the visual image and audio stored on the video frame memory.

The video frame can display a listing of files. Each video or audio input may retain the identifier assigned by the camera, scanner or audio source. The user may assign new identifiers.

The video frame memory will be divisible into files. The files can serve as albums videos and photos of family and friends. These files can be stored on the video frame memory. In another embodiment, the user may download images or sounds to designated files.

The controls and components incorporated into the video frame allow the user to erase sections of a video clip, e.g., a section of a video clip that is blurred. The controls and components allow the user pause a video clip at a selected frame. This paused video segment can be downloaded as a still photo into the memory of the video frame. The still photo made from the video can used to make a physical photograph.

The remote control device will also have a “zoom in” “zoom out” button so you can zoom in zoom out up to 16 times magnification from a photograph (still photo) or video. This magnification capability also extends to a display of video or photograph presentation on a connected television. The whole video frame receives any video chip or picture chip with sound or movement.

Any picture or video on the video frame can be rotated up to 360° degrees using the controls on the remote so when you rotate a picture on the camera you can view it just like you want.

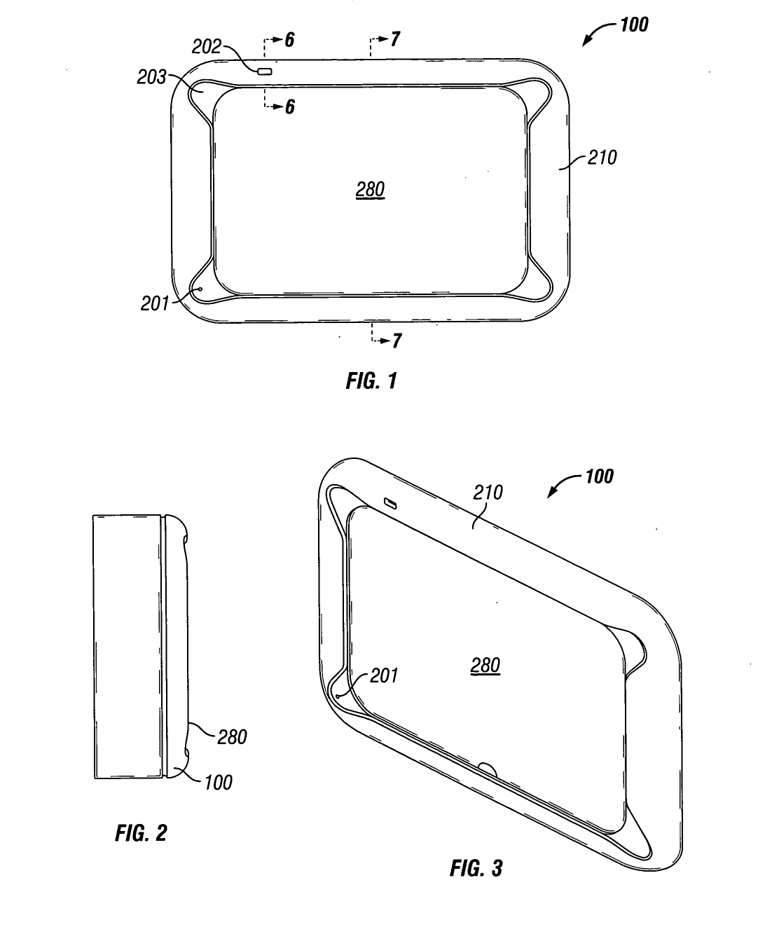

Turning now to the illustrations, FIG. 1 illustrates one embodiment of the device 100. Illustrated is a microphone input port 201. The four sided frame 210 is illustrated and framing the LCD screen 280. An optional indentation 203 for each frame corner is illustrated. An infra-red signal receiving port 202 is also illustrated. FIG. 2 is a side view of the video frame 100 and the TFT LCD touch screen. FIG. 3 is a perspective view of the video frame 100 illustrating the TFT LCD touch screen 280, the microphone port 201 and the decorative frame 210.

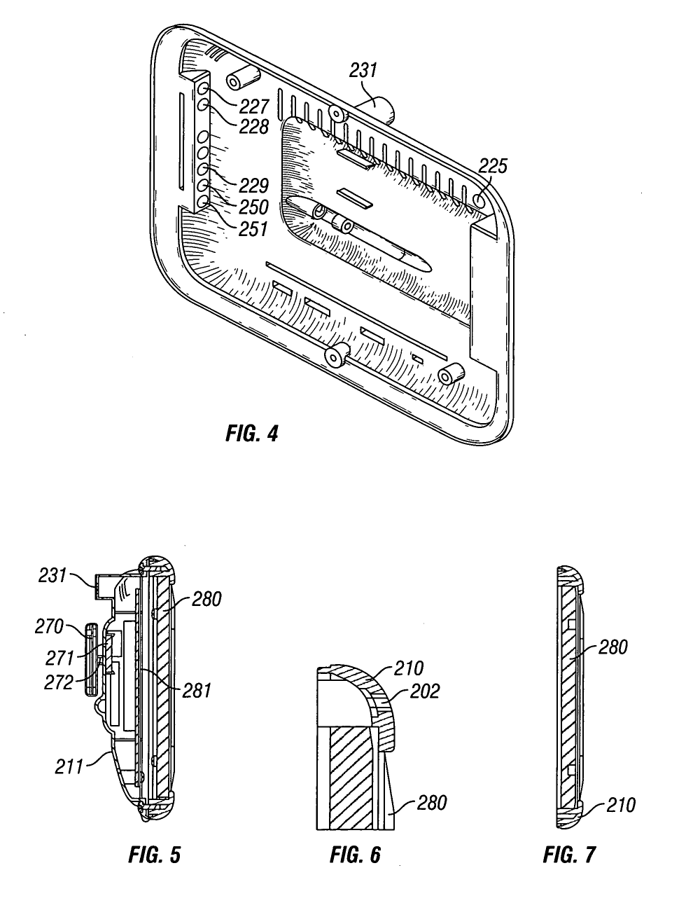

FIG. 4 illustrates an interior view of the back cover panel forming part of the video frame. Illustrated are an audio input port 227, audio output port 228, video in port 229, video out port 250 and a Universal Serial Bus (USB) 251.

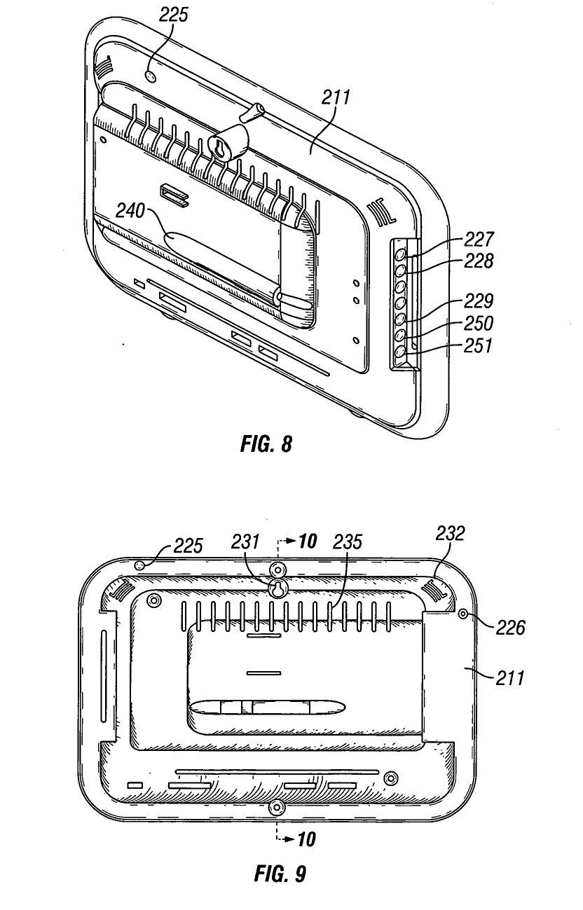

FIGS. 8 and 9 illustrates an exterior view of the back cover 211 of the video frame. Illustrated are the slotted speaker covers 232 and wall mounting attachment 231 for the horizontal position. Also illustrated are an audio input port 227, audio output port 228, video in port 229, video out port 250 and a USB port 251. Also illustrated are heat ventilation slots 235.

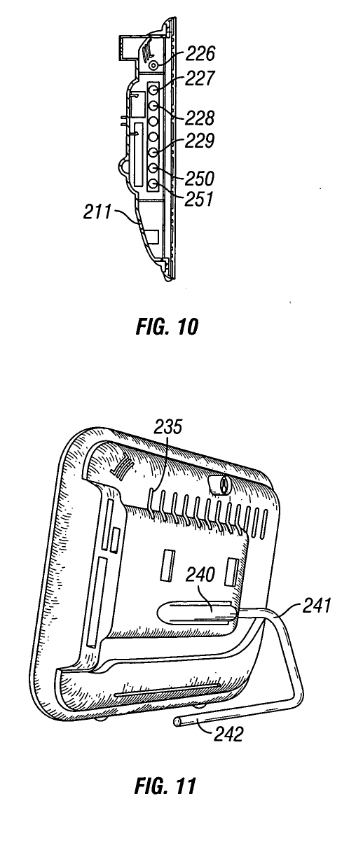

FIG. 10 is a cross sectional view of the video frame showing the back 211, an audio input port 227, audio output port 228, video in port 229, video out port 250 and a USB 251. FIG. 11 illustrates another embodiment wherein the video frame utilizes a bracket 241. One end of the bracket fits into a bracket holder 240 at the back of the video frame 211 and the other end 242 forms a stand holding the video frame upright on a flat surfaces, e.g., a desk or table.

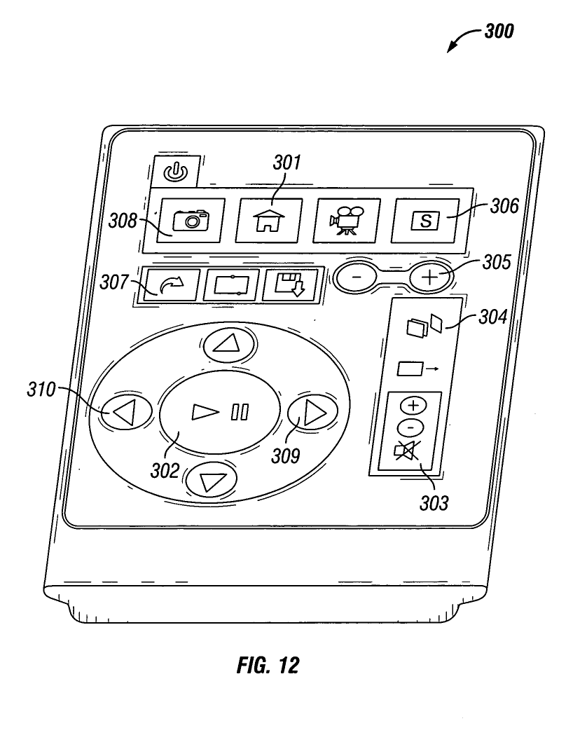

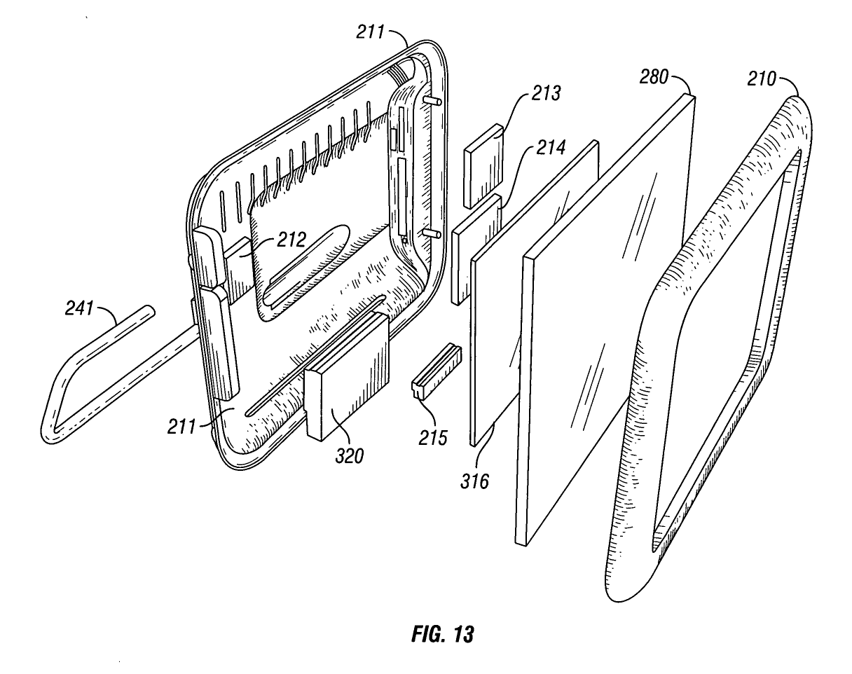

FIG. 12 illustrates one embodiment of the remote control component 300. In the embodiment illustrated, the control contains a Home Menu 301 button that activates the touch screen menu. Also available is a Mode Select button 308 that allows the user to toggle/jump between the images and video mode. The three Picture Action buttons 307 enable the user to rotate, save a picture and also to view a set of pictures in a continuously repeating loop. The Central Pause/Play button 302 allows the user to take a still shot of a video and store it in the internal memory of the video picture frame. The two Next/Previous buttons 309, 310 control the sequence of presentation. The control also contains three Volume Control buttons 303, include a mute button. The user can set the volume of the video that is being played or the music that the picture frame plays in the background of the images. The Zoom Control 305 allows the user to zoom in and zoom out of a still image. The Settings button 306 shows the properties of the video frame, including quantity of memory used, and memory left. The user can go into this Settings menu and change the brightness, tone, contrast and other qualities of the image or sound as well as modify the date, time, alarm settings, etc.

FIG. 13 is an exploded perspective view of the video frame, the TFT LCD touch screen 280, the memory unit (preferably 10 GB PCB with built in flash memory 316), battery pack (preferably Lithium ion) 320, audio-pack ports 212 (input and output), the video frame back cover 211, back stand 241, SD/MMC card reader 213, CF II microdrive (hard disk) reader 214 or compact flash (CF) II slot LED array 215.

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention.

While specific embodiments have been illustrated and described, numerous modifications are possible without departing from the spirit of the invention, and the scope of protection is only limited by the scope of the accompanying claims.

What we claim is:

1. A video frame comprising:
a) a touch screen LCD;
b) a power supply;
c) a memory component;
d) video and audio input and output jacks adaptable to DVD and VCR players, cameras and mp3s; and
e) speakers located within the video frame; and
f) a clock and alarm component in communication with the touch screen LCD, audio recorder and player and a video recorder and player, and memory component.

2. The video frame of claim 1 further comprising an infra-red remote control device and an infra-red signal receiver within the video frame.

3. The video frame of claim 1 further comprising 10 gigabytes of memory.

4. The video frame of claim 1 powered by batteries.

5. The video frame of claim 1 powered by AC current.

6. The video frame of claim 1 further comprising a user selected visual display and sound activated by a clock component.

7. The video frame of claim 1 further comprising connecting audio and video cables to a television to display the visual image and audio stored on the video frame memory.

8. The video frame of claim 1 further comprising controllably magnifying the visual image displayed on the television screen.

9. The video frame of claim 1 further comprising a frame component surrounding the touch screen LCD wherein the frame comprises a plurality of Light Emitting Diodes that change color in correlation to the strength of video frame batteries.
